(19) United States
(12) Patent Application Publication
(10) Pub. No.: US 2016/0205154 A1
(43) Pub. Date: Jul. 14, 2016

(54) PROVIDING A MEETING LINK TO A PARTICIPANT WHO HAS LEFT A LOCATION OF THE MEETING

(71) Applicants: Haihua Huang, Suzhou (CN); Yuan Wu, Suzhou (CN); Dapeng Sun, Suzhou (CN); Qiulan Huang, Suzhou (CN); Jian Hua, Suzhou (CN)

(72) Inventors: Haihua Huang, Suzhou (CN); Yuan Wu, Suzhou (CN); Dapeng Sun, Suzhou (CN); Qiulan Huang, Suzhou (CN); Jian Hua, Suzhou (CN)

(73) Assignee: Cisco Technology, Inc., San Jose, CA (US)

(21) Appl. No.: 14/592,093

(22) Filed: Jan. 8, 2015

(51) Int. Cl. H04L 29/06; G06F 17/30

(52) U.S. Cl. CPC H04L 65/403; G06F 17/30882

(57) ABSTRACT

In one embodiment, a method includes identifying a first device as being located at a first physical location associated with a meeting, and determining when the first device is no longer located at the first physical location during the meeting. When it is determined that the first device is no longer located at the first physical location during the meeting, the method also includes determining whether to provide a meeting link to the first device, the meeting link being arranged to allow the first device to join the meeting. Finally, the method includes providing the meeting link to the first device if it is determined that the meeting link is to be provided to the first device.

### TECHNICAL FIELD

The disclosure relates generally to collaborative environments. More particularly, the disclosure relates to providing a link to a device that may be used to join a meeting in progress after a user in possession of the device leaves a physical location associated with the meeting.

### BACKGROUND

Meetings are often such that participants gather together in a particular location, as for example a meeting room or a conference room, to initiate an online meeting with parties who are unable to gather in the particular location. Online meetings often include audio and visual components, and may include, but are not limited to including, telepresence meetings. Participants who gather in a particular location to attend an online meeting often participate using shared equipment, e.g., a computing device and/or a conference phone, at the particular location. At times, participants may find it necessary to leave the particular location.

A participant who leaves a particular location from which he or she was attending an online meeting may decide to participate in the online meeting remotely with respect to the particular location. By way of example, a participant who leaves a conference room that is a site for an online meeting may decide to join the online meeting using a device in his or her possession such as a cell phone or a laptop computer.

When a participant who has left a location that is a site for an online meeting decides to continue participating in the online meeting using a device in his or her possession, it may be time consuming and, hence, inefficient for the participant to locate a link that may be used to join the online meeting. While searching for such a link, e.g., while searching through emails for an email containing the link, the participant may miss important content of the online meeting.

### BRIEF DESCRIPTION OF THE DRAWINGS

The disclosure will be readily understood by the following detailed description in conjunction with the accompanying drawings in which:

FIG. 1 is a process flow diagram which illustrates a method of providing a link to join a meeting in accordance with an embodiment.

FIG. 2A is a diagrammatic representation of a meeting supported by a meeting or conference server at a time t1 in accordance with an embodiment.

FIG. 2B is a diagrammatic representation of a meeting supported by a meeting server, e.g., meeting server 212 of FIG. 2A, at a time t2 at which a device is detected as leaving a location associated with the meeting in accordance with an embodiment.

FIG. 2C is a diagrammatic representation of a meeting supported by a meeting server, e.g., meeting server 212 of FIG. 2A, at a time t3 at which a device is provided with a link arranged to be used to join the meeting in accordance with an embodiment.

FIG. 2D is a diagrammatic representation of a meeting supported by a meeting server, e.g., meeting server 212 of FIG. 2A, at a time t4 at which a device joins the meeting using a link arranged to be used to join the meeting in accordance with an embodiment.

FIGS. 3A and 3B are a process flow diagram which illustrates a method of determining whether to send a meeting link to a device, e.g., step 121 of FIG. 1, in accordance with an embodiment of the present invention.

FIG. 4 is a diagrammatic representation of a meeting server arranged to provide a link that may be used to join a meeting in accordance with an embodiment.

FIG. 5 is a diagrammatic representation of a device on which a meeting link is displayed in accordance with an embodiment.

FIG. 6A is a diagrammatic representation of a meeting supported by a meeting or conference server in which a device in a meeting room may be paired to an endpoint in the meeting room at a time t1 in accordance with an embodiment.

FIG. 6B is a diagrammatic representation of a meeting supported by a meeting server, e.g., meeting server 612 of FIG. 6A, at a time t2 at which a device is detected as leaving a location associated with the meeting in accordance with an embodiment.

FIG. 6C is a diagrammatic representation of a meeting supported by a meeting server, e.g., meeting server 612 of FIG. 6A, at a time t3 at which a device is provided with a link arranged to be used to join the meeting in accordance with an embodiment.

FIG. 6D is a diagrammatic representation of a meeting supported by a meeting server, e.g., meeting server 612 of FIG. 6A, at a time t4 at which a device joins the meeting using a link arranged to be used to join the meeting in accordance with an embodiment.

### DESCRIPTION OF EXAMPLE EMBODIMENTS

### General Overview

According to one aspect, a method includes identifying a first device as being located at a first physical location associated with a meeting, and determining when the first device is no longer located at the first physical location during the meeting. When it is determined that the first device is no longer located at the first physical location during the meeting, the method also includes determining whether to provide a meeting link to the first device, the meeting link being arranged to allow the first device to join the meeting. Finally, the method includes providing the meeting link to the first device if it is determined that the meeting link is to be provided to the first device. In one embodiment, the first device is an active device.

### DESCRIPTION

Many meetings include multiple participants located at a physical location who participate in the meetings using shared equipment at the physical location. By way of example, an online meeting such as a telepresence meeting or a collaborative session may be attended by multiple participants who are in attendance at a particular location using a shared computing device and/or conference phone at the particular location.

When a party attending an online meeting with other parties at a physical location leaves the physical location, he or she may decide to join the online meeting using a device in his possession. It may be inefficient for such a party to join the online meeting using a device in his possession, as locating the information needed to join the online meeting, e.g., a meeting link, may be a time-consuming and, hence, inefficient process.

In one embodiment, when a device that was physically present at a physical location associated with a meeting, e.g., an online meeting such as a collaborative session is detected as leaving the physical location, a meeting link that may be used to join the meeting may be provided to the device. Providing a meeting link to a device which has left a physical location associated with a meeting while the meeting is ongoing allows the meeting link to be easily accessed using the device. Hence, the device may be used by a user of the device to efficiently join the meeting.

A meeting server or a conference server may identify devices that are physically present at a location associated with a meeting, e.g., a meeting site, and determine when the devices leave the location while the meeting is in progress. The meeting server may assess whether to send a meeting link to a device which has left a meeting site, and provide the meeting link to the device as appropriate. In one embodiment, meeting links are substantially only provided to authenticated devices. By providing meeting links substantially only to authenticated devices, the likelihood that an unauthorized party may gain access to a meeting may be reduced.

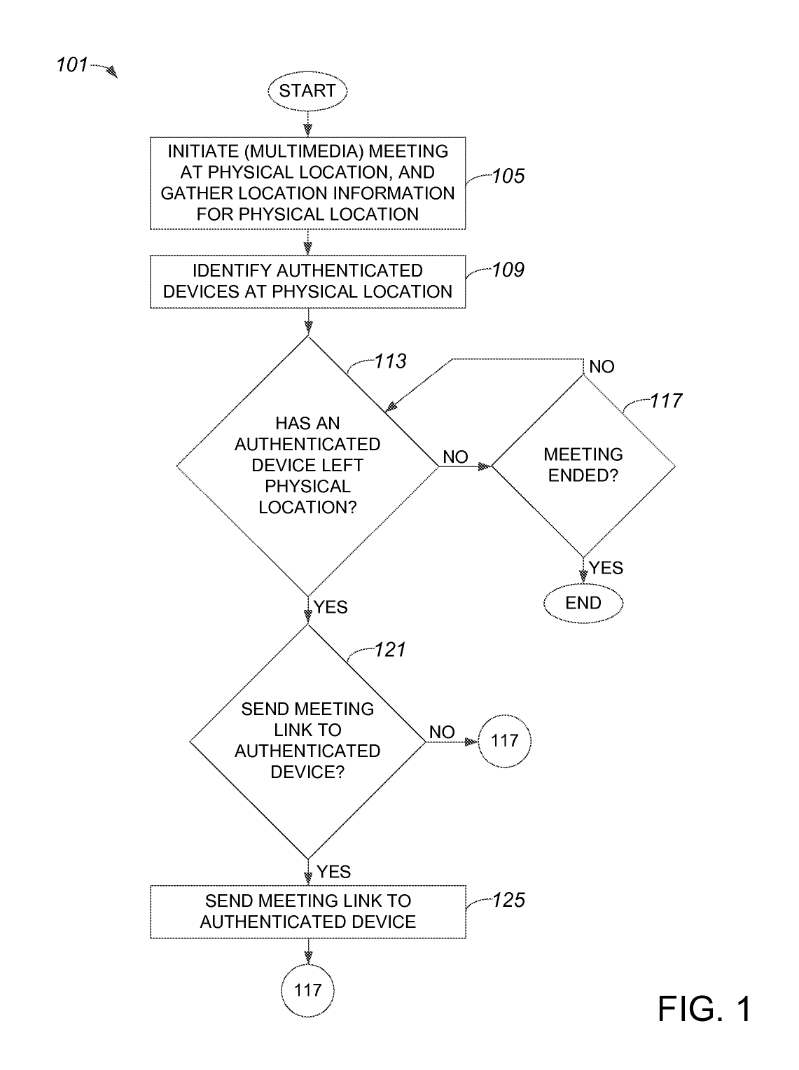

Referring initially to FIG. 1, method of providing a link that may be used to join a meeting that is in progress will be described in accordance with an embodiment. A method 101 of providing a link that may be used to join a meeting, e.g., a meeting link, begins at step 105 in which a meeting or a conference is initiated at a physical location, and location information for the physical location is gathered or otherwise obtained. Initiating a meeting or a conference at a physical location may involve initiating a meeting in which at least one participant in the meeting is present at the physical location, e.g., a conference room such as a telepresence conference room. Gathering location information for a physical location may include, but is not limited to including, identifying a physical location from which a device such as a conference phone has joined a meeting. In one embodiment, a meeting server or a conference server initiates a meeting, as for example a multimedia meeting or a collaborative session, and obtains location information for a physical location associated with the meeting.

Once the meeting is initiated at the physical location, authenticated devices that are present at the physical location are identified in step 109. Identifying authenticated devices may generally involve identifying trusted devices that are at the physical location. Methods used to identify the authenticated devices may vary widely. By way of example, a sensing apparatus may be used to detect devices present at the physical location, and may ascertain which of the detected devices are authenticated or otherwise known. Alternatively, participants in the meeting who are present at the physical location may be identified, and a meeting server may access a database to identify devices associated with the participants. In one embodiment, participants in a meeting may effectively register their devices, e.g., cell or mobile phones, such that a meeting server may consider the registered devices as authenticated.

A determination is made in step 113 as to whether an authenticated device has left the physical location. In other words, it is determined if an authenticated device that was present at the physical location is no longer present at the physical location. It should be appreciated that such a determination is generally made during the course of the meeting, i.e., while the meeting is still in progress. Determining whether an authenticated device has left the physical location may include monitoring or otherwise observing all authenticated devices at the physical location, and identifying when one of the authenticated devices which was previously at the physical location is no longer at the physical location.

If the determination in step 113 is that no authenticated device has left the physical location, process flow moves to step 117 in which it is determined if the meeting has ended. If it is determined that the meeting has not ended, process flow returns to step 113 in which it is determined whether an authenticated device has left the physical location. Alternatively, if it is determined that the meeting has ended, the method of providing a link which may be used to join a meeting is completed.

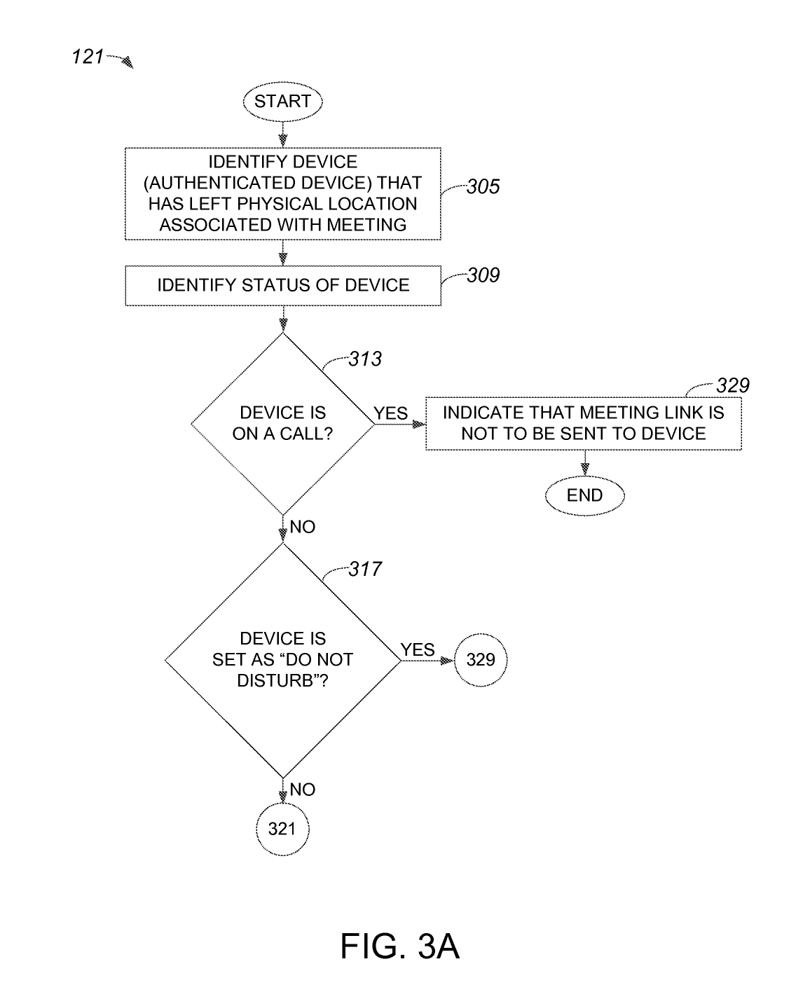

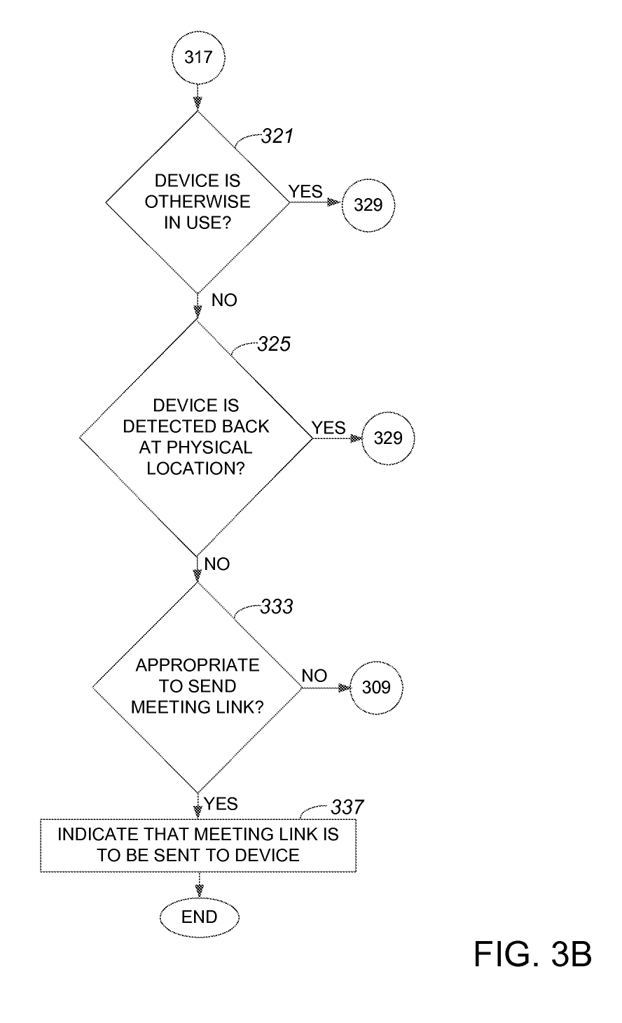

Returning to step 113, if it is determined that an authenticated device has left the physical location, then in step 121, a determination is made as to whether a meeting link is to be sent or otherwise provided to the authenticated device which has left the physical location. Such a determination may include determining whether the authenticated device is in use for another purpose. For example, if the authenticated device is a cell phone that is being used to make a call, it may be determined that a meeting link is not to be sent to the cell phone. One process of determining whether to send a meeting link to an authenticated device which has left a physical location will be described below with reference to FIGS. 3A and 3B.

If the determination in step 121 is that a meeting link is to be sent to the authenticated device, a meeting link is sent to the authenticated device in step 125. In general, a meeting server may be arranged to send the meeting link to the authenticated device. The meeting link may be sent by any suitable method. Suitable methods include, but are not limited to including, sending a text message that includes the meeting link to an address or a phone number associated with the authenticated device, sending an email that includes the meeting link to an email address associated with the authenticated device, or otherwise pushing the link to the authenticated device. For example, a meeting link may be provided as a pop-up window associated with a meeting or conference application, e.g., a telepresence application such as Cisco WebEx Telepresence available commercially from Cisco Systems, Inc. After the meeting link is sent to the authenticated device, process flow returns to step 117 in which it is determined whether another authenticated device has left the physical location associated with the meeting.

Alternatively, if it is determined in step 121 that a meeting link is not to be sent to the authenticated device, the indication may be that the authenticated device is unlikely to join the meeting by accessing the meeting link. When it is determined that a meeting link is not to be sent to the authenticated device, process flow returns to step 117 in which it is determined if another authenticated device has left the physical location.

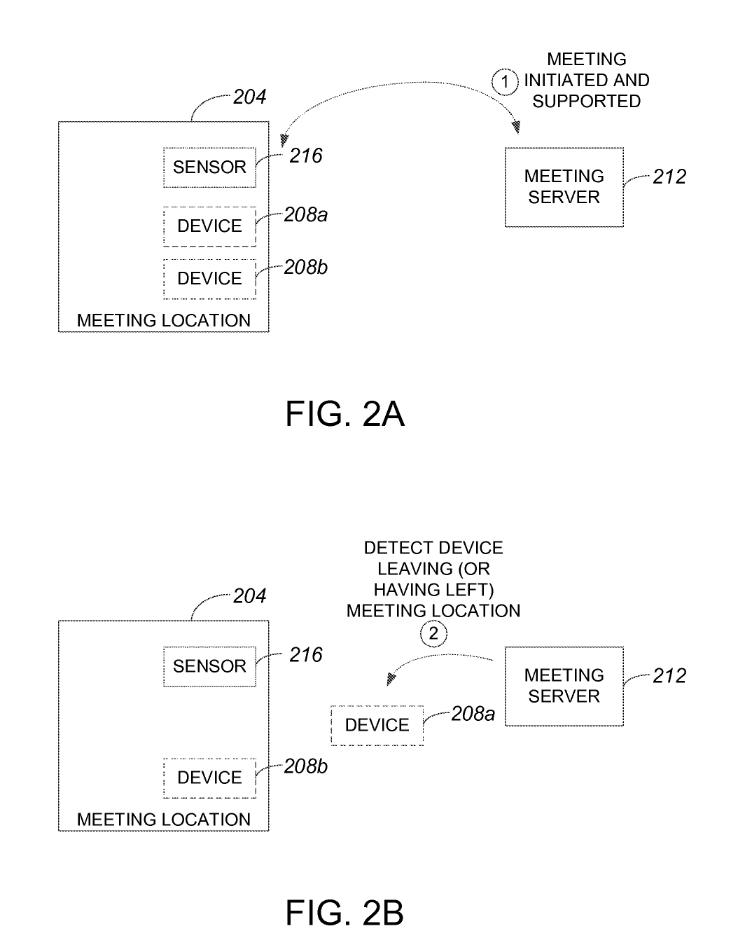

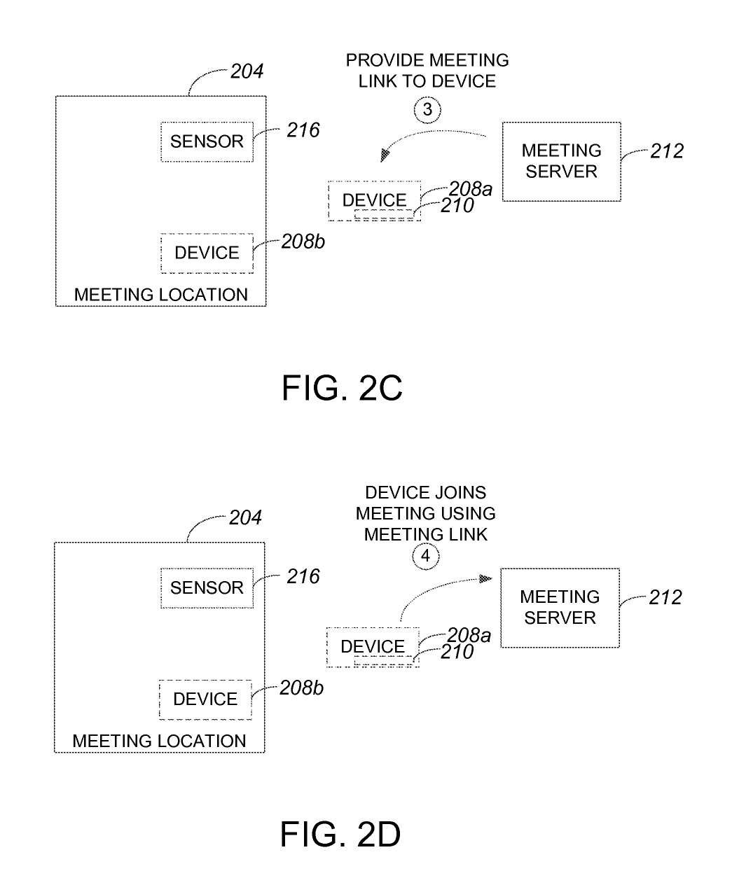

FIG. 2A is a diagrammatic representation of a meeting supported by a meeting or conference server at a time t1 in accordance with an embodiment. At a time t1, a plurality of devices 208a, 208b are located at a meeting location 204, which is generally a physical location. In one embodiment, an optional sensor 216 detects that devices 208a, 208b are present at meeting location 204. Devices 208a, 208b may generally be authenticated, e.g., trusted, and may include mobile devices such as cell phones, tablets, and/or laptop computers.

A meeting server 212 initiates and supports a meeting at meeting location 204. In one embodiment, meeting server 212 may have access to information which indicates whether devices 208a, 208b are authenticated. It should be appreciated that meeting server 212 may cooperate with optional sensor 216 to authenticate devices 208a, 208b.

The meeting supported by meeting server 212 generally includes at least one participant, e.g., a participant who is in possession of a device 208a, 208b, who is present at meeting location 204. Although meeting server 212 is shown as not being at meeting location 204, it should be appreciated that meeting server 212 may instead be substantially on site at meeting location 204. In other words, while meeting server 212 is shown as being remote with respect to meeting location 204, meeting server 212 is not limited to being remote with respect to meeting location 204 and may instead be present at meeting location 204.

Meeting server 212 may determine that devices 208a, 208b are present at meeting location 204 using any suitable method. For example, meeting server 212 may obtain information from sensor 216 which indicates that devices 208a, 208b are located at meeting location 204. Such information may be obtained through a network (not shown).

During the course of the meeting, a participant may leave meeting location 204. In the described embodiment, when a participant leaves meeting location 204, device 208a leaves meeting location 204 and, as such, is no longer detected at meeting location 204. As shown in FIG. 2B, at a time t2, device 208a is detected as leaving, or having left, meeting location 204. Meeting server 212 may either detect that device 208a is no longer at meeting location 204, or meeting server 212 may obtain information which indicates that device 208a is no longer at meeting location 204. By way of example, optional sensor 216 located at meeting location 204 may detect that device 208a is no longer located at meeting location 204 and provide information relating to device 208a to meeting server 212.

Once meeting server 212 detects or otherwise determines that device 208a is no longer present at meeting location 204, meeting server 212 may ascertain whether a meeting link is to be provided to device 208a to enable device 208a to join the meeting associated with meeting location 204. In other words, meeting server 212 may determine whether to provide a meeting link to device 208a such that device 208a may be used to remotely join the meeting associated with meeting location 204. In the described embodiment, meeting server 212 determines that device 208a is to be provided with a meeting link. FIG. 2C is a diagrammatic representation of the meeting supported by meeting server 212 at a time t3 at which device 208a is provided with a meeting link 210 arranged to be used to join the meeting. At time t3, link 210 is provided to device 208a. Link 210 is arranged such that device 208a may activate or otherwise use meeting link 210 to join the meeting.

At a time t4, as shown in FIG. 2D, device 208a uses meeting link 210 to join the meeting. In general, when device 208a uses meeting link 210 to join the meeting, device 208a may activate meeting link 210 and communicate with meeting server 212. Upon detecting that device 208a has activated or otherwise accessed meeting link 210, meeting server 212 may effectively add device 208a into the meeting such that device 208a may participate in the meeting remotely.

As mentioned above with respect to FIG. 1, a meeting server may determine whether to provide a meeting link to a device which has left a physical location associated with a meeting. A determination of whether to provide a meeting link to a device which has left a physical location associated with a meeting may include any number of considerations. With reference to FIGS. 3A and 3B, a method of determining whether to send a meeting link to a device, e.g., step 121 of FIG. 1, will be described in accordance with an embodiment of the present invention. In the described embodiment, a determination of whether to send a meeting link to a device occurs substantially only if the device is authenticated, or otherwise known to be trusted.

A method 121 of determining whether to send a meeting link to a device begins in step 305 in which a device which has left a physical location associated with a meeting is identified. In one embodiment, the device is an authenticated device in the possession of a party who was previously at the physical location but has departed the physical location. A meeting server may determine that the device has left the physical location.

A status of the device is identified in step 309. Identifying the status of the device may include identifying if the device is in a busy state, and/or effectively assessing a likelihood of the device remotely joining the meeting associated with the physical location. The device may be identified as being in a busy state, for example, if the device is on a call, set in a “do not disturb” state, or otherwise in use.

Once the status of the device is identified, a determination is made in step 313 as to whether the device is on a call, i.e., whether the device is currently engaged in a call. If the determination is that the device is on a call, the meeting server may indicate that a meeting link is not to be sent to the device in step 329, and the method of determining whether to send a meeting link to a device is completed.

Alternatively, if it is determined in step 313 that the device is not on a call, a determination is made in step 317 as to whether the device is in a “do not disturb” state. If it is determined in step 317 that the device is in a “do not disturb” state, process flow moves to step 329 in which the meeting server may indicate that a meeting link is not to be sent to the device, and the method of determining whether to send a meeting link to a device is completed.

If, however, it is determined in step 317 that the device is not in a “do not disturb” state, process flow moves to step 321 in which it is determined if the device is otherwise in use. A device may be in use, but not on a call or in a “do not disturb” state, for a variety of different reasons. In general, a device may be in use when the device is engaging in substantially real-time communications, as for example, when the device is on a call, texting, or in a meeting.

If it is determined that the device is otherwise in use, process flow moves to step 329 in which the meeting server may indicate that a meeting link is not to be sent to the device, and the method of determining whether to send a meeting link to a device is completed. Alternatively, if it is determined that the device is not otherwise in use, process flow proceeds from step 321 to step 325 in which a determination is made as to whether the device is detected back at the physical location associated with the meeting. If it is determined that the device is detected back at the physical location, the implication is that a possessor or user of the device has returned to the meeting. As such, the device is unlikely to be used to join the meeting. Accordingly, process flow moves from step 325 to step 329 in which the meeting server may indicate that a meeting link is not to be sent to the device, and the method of determining whether to send a meeting link to a device is completed.

On the other hand, if the determination in step 325 is that the device is not detected back at the physical location, it is determined in step 333 whether it is otherwise appropriate to send a meeting link. In one embodiment, determining whether it is otherwise appropriate to send a meeting link may include determining whether a threshold amount of time has passed A threshold amount of time may correspond to an amount of time that a device may be away from the physical location before the device is considered to be likely to be used to join the meeting associated with the physical location. The threshold amount of time may vary widely, and may be on the order of a few seconds.

If it is determined in step 333 that it is not appropriate to send a meeting link, process flow returns to step 309 in which it is a status of the device is identified. Alternatively, if the determination in step 333 is that the threshold amount of time has passed, a meeting server indicates that a meeting link is to be sent to the device in step 337. After the meeting server indicates that a meeting link is to be sent to the device, the method of determining whether to send a meeting link to a device is completed.

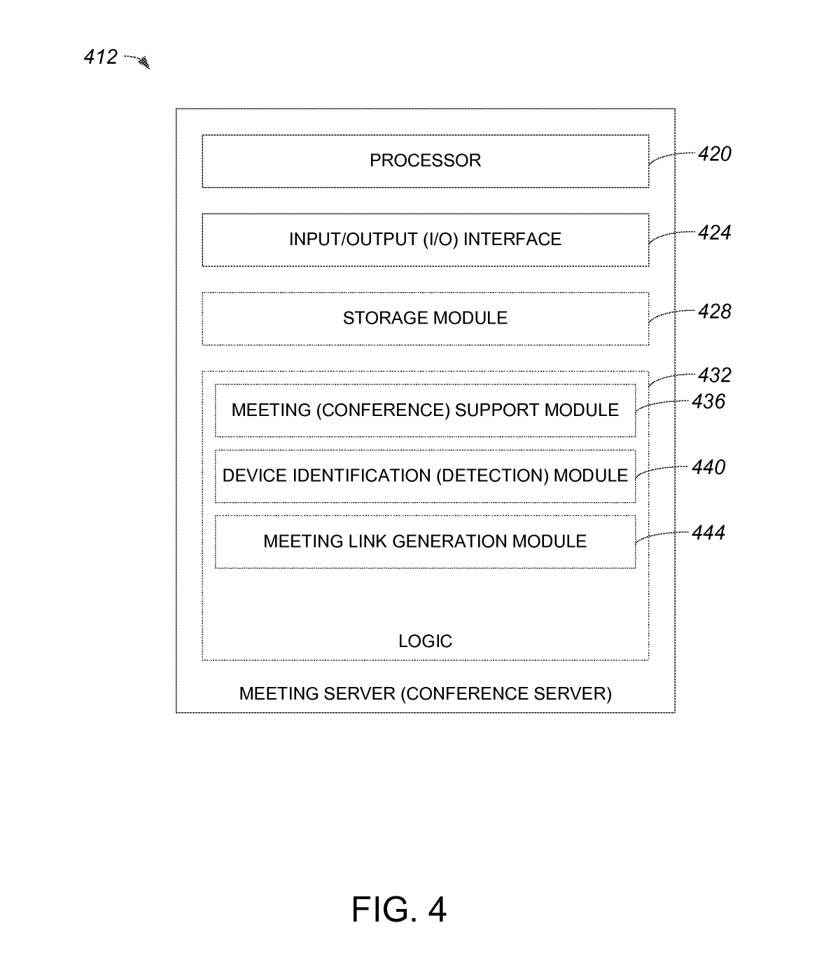

FIG. 4 is a diagrammatic representation of a meeting server or a conference server arranged to provide a link that may be used to join a meeting in accordance with an embodiment. A meeting server 412 includes a processor 420, an input/output (I/O) interface 424, an optional storage module 428, and logic 432.

I/O interface 424 is configured to allow meeting server 412 to communicate on a network, as for example with a client or a conference phone. Storage module 428 is arranged to store data or information that may be used by meeting server 412 to support meetings or conferences, e.g., geolocation information associated with physical locations for meetings supported by meeting server 412. Storage module 428 may also store information that may be used to authenticate devices, e.g., devices at a physical location associated with a meeting supported by meeting server 412, as well as geolocation information associated with the devices. It should be appreciated that in lieu of storing and accessing information stored in storage module 428, meeting server 412 may instead store and access information at remote storage locations through the use of I/O interface 424.

Logic 432 includes hardware and/or software logic arranged to be executed by processor 420. Logic 432 includes a meeting or conference support module 436, a device identification or detection module 440, and a meeting link generation module 444.

Meeting or conference support module 436 is arranged to initiate, to manage, and to otherwise support a meeting. The meeting supported by meeting or conference support module 436 may generally be an audio meeting, a visual meeting, and/or a collaborative meeting.

Device identification or detection module 440 is arranged to identify devices that are present at a physical location associated with a meeting supported by meeting server 412. In one embodiment, device identification or detection module 440 may authenticate devices that are present at a physical location associated with a meeting. It should be appreciated that device identification or detection module 440 may use information obtained from sensors at a physical location associated with a meeting, or a meeting location, to identify and/or to authenticate devices at the physical location. Device identification and detection module 440 is also arranged to identify when a device that was present at a physical location during a meeting is no longer present at the physical location while the meeting is still ongoing. In one embodiment, device identification and detection module 440 is also arranged to determine when a device which has left a physical location associated with a meeting has returned to the physical location.

Meeting link generation module 444 is arranged to determine whether to provide a meeting link to a device that the device may use to join a meeting supported by meeting server 412, and to provide the meeting link to the device if the determination is that the meeting link is to be provided. Meeting link generation module 444 may provide a meeting link to a device using any suitable method. Suitable methods may include, but are not limited to including, sending a meeting link in a short message service (SMS) or text message, sending a meeting link in an email, and/or otherwise pushing the meeting link to the device.

Meeting or conference support module 436 is further arranged to allow a device to join a meeting when the device activates a meeting link provided by meeting link generation module 444. In other words, meeting or conference support module 436 is arranged to enable a device to virtually or remotely join a meeting associated with a physical location when meeting or conference support module 436 determines that the device has activated a meeting link provided to the device by meeting link generation module 444.

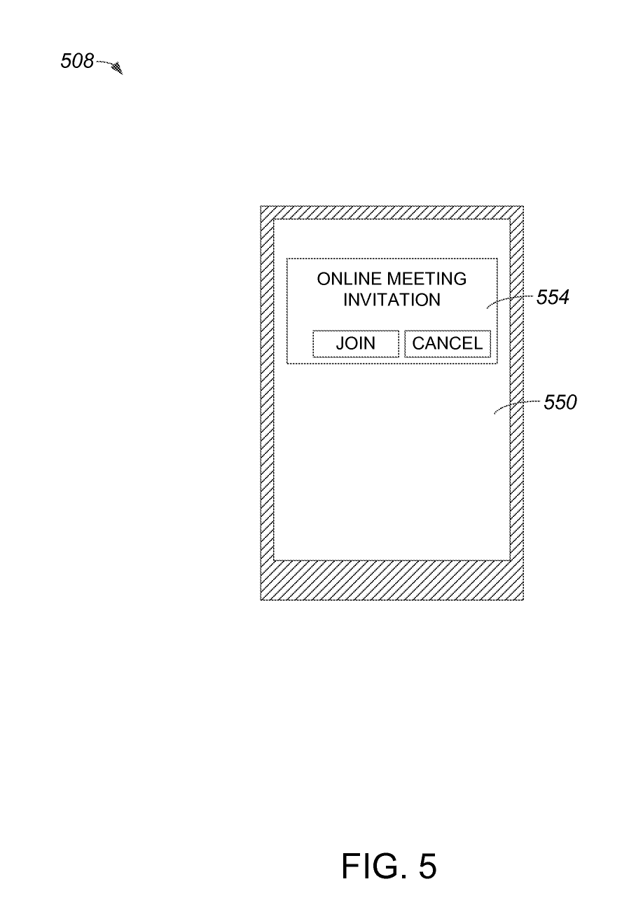

Referring next to FIG. 5, one suitable meeting link that is provided to a device which has left a physical location associated with a meeting, or a meeting location, will be described in accordance with an embodiment. A device 508, which may be a cell phone or a mobile phone, includes a display screen 550. A meeting link 554, which is arranged to allow a user of device 508 to use device 508 to join a meeting, is displayed on display screen 550.

Determining when a device has left a physical location may include, in one embodiment, a determination of when the device has unpaired itself from an endpoint at the physical location. By way of example, a telepresence endpoint at a physical location may pair with a device when the device is at the physical location, and may unpair with the device when the device is no longer at the physical location. As such, a device may be determined to no longer be at a physical location based on whether the device has unpaired from an endpoint.

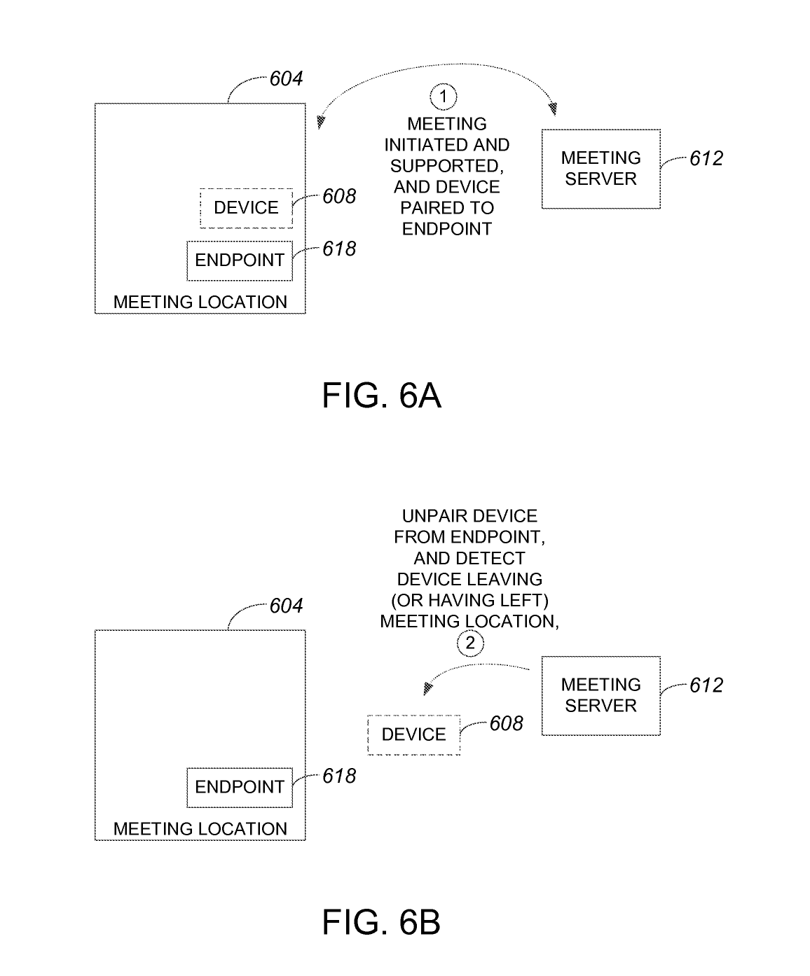

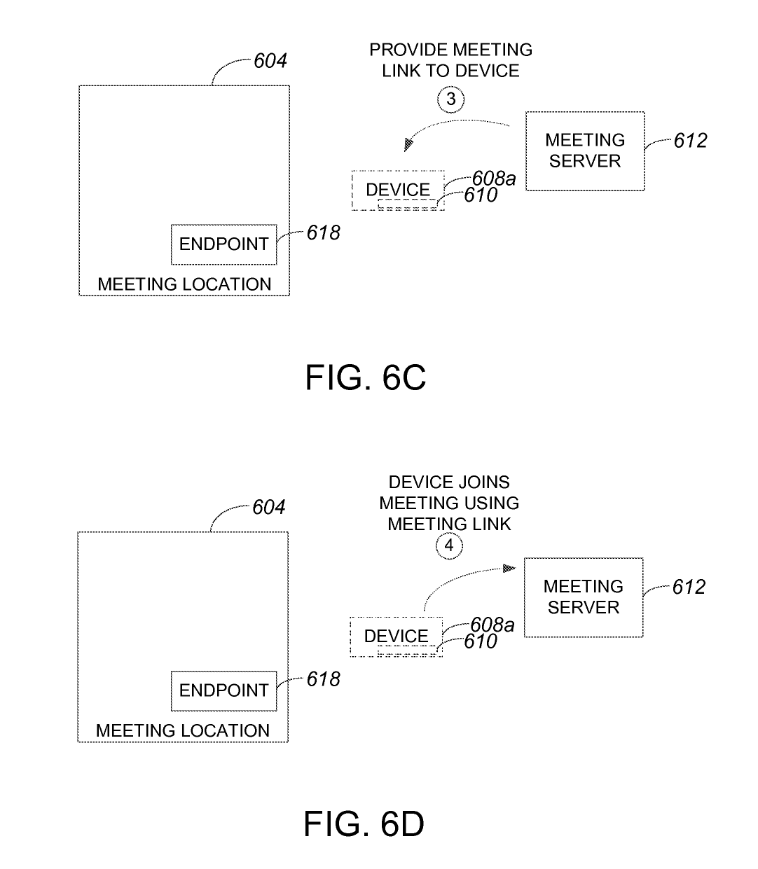

FIG. 6A is a diagrammatic representation of a meeting supported by a meeting or conference server in which a device in a meeting room may be paired to an endpoint in the meeting room at a time t1 in accordance with an embodiment. At a time t1, a device 608 is located at a meeting location 604, which is generally a physical location such as a meeting room. Device 608 may generally be authenticated.

An endpoint 618, which is located at meeting location 604, is arranged to pair with device 608 when device 608 is detected at meeting location 604. Endpoint 618, which may be a telepresence endpoint or a conference bridge, may pair with device 608 using any suitable pairing technique. Suitable pairing techniques may include, but are not limited to including, ultrasonic pairing, intelligent proximity pairing, and pairing using a voice path from device 608 to endpoint 618.

A meeting server 612 initiates and supports a meeting at meeting location 604, e.g., through the use of endpoint 618. The meeting supported by meeting server 612 generally includes at least one participant, e.g., a participant who is in possession of a device 608, who is present at meeting location 604. Although meeting server 612 is shown as not being at meeting location 604, it should be appreciated that meeting server 612 may instead be substantially on site at meeting location 604.

Meeting server 612 may determine that device 608 is present at meeting location 604 using any suitable method. For example, meeting server 512 may obtain information from endpoint 618 which indicates that device 608 is paired with endpoint 618 and is, hence, located at meeting location 604. Such information may be obtained through a network (not shown).

During the course of the meeting, a participant may leave meeting location 604. In the described embodiment, when a participant leaves meeting location 604, device 608 leaves meeting location 604. As device 608 leaves meeting location 604, device 608 may be unpaired from endpoint 618. FIG. 6B is a diagrammatic representation of a meeting supported by meeting server 612 at a time t2 at which device 608 is unpaired from endpoint 618 and, as such, detected as leaving a meeting location 604. A time t2, device 608 and endpoint 618 are unpaired, as device 608 is no longer present at meeting location 604. As a result, endpoint 618 may effectively notify meeting server 612 that device 608 is no longer detected at location 604.

Once meeting server 612 is effectively notified that device 608 is no longer present at meeting location 604, meeting server 612 may ascertain whether a meeting link is to be provided to device 608 to enable device 608 to join the meeting associated with meeting location 604. In the described embodiment, meeting server 612 determines that device 608 is to be provided with a meeting link. FIG. 6C is a diagrammatic representation of the meeting supported by meeting server 612 at a time t3 at which device 608 is provided with a meeting link 260 arranged to be used to join the meeting. At time t3, link 610 is provided to device 608. Link 610 is arranged such that device 608 may activate or otherwise use meeting link 610 to join the meeting.

At a time t4, as shown in FIG. 6D, device 608 uses meeting link 610 to join the meeting. That is, device 608 may activate meeting link 610 and, thus, communicate with meeting server 612. Upon detecting that device 608 has activated or otherwise accessed meeting link 610, meeting server 612 may effectively add device 608 into the meeting such that device 608 may participate in the meeting remotely.

Although only a few embodiments have been described in this disclosure, it should be understood that the disclosure may be embodied in many other specific forms without departing from the spirit or the scope of the present disclosure. By way of example, any suitable method may be used to determine whether a device has left a physical location associated with the meeting. For instance, if the physical location is a conference room, if it is detected that the device is no longer within the confines of the conference room, the determination may be that the device has departed the physical location. Sensors located at or near the physical location may be used to determine when a device has left a physical location, although it should be appreciated that determining when a device has left a physical location is not limited to being associated with the use of sensors located at or near the physical location.

As described above, a meeting server may detect when the device has departed a meeting location through the use of sensors. In lieu of detecting when a device has departed a meeting location through the use of sensors, a party such as a meeting owner who is present at the meeting location may instead provide information to the meeting server which indicates that the device has departed the meeting location. More generally, while information which indicates that a device has left a physical location associated with a meeting may be substantially automatically obtained by a meeting server, the information may instead be obtained substantially manually by the meeting server.

The number of times a meeting link is provided to a device which has departed from a physical location associated with a meeting may vary widely. In one embodiment, a meeting link may be sent to a device a single time. It should be appreciated, however, that in another embodiment, if a device has not used a meeting link to join a meeting after a predetermined amount of time has elapsed, the meeting link may once again be provided to the device.

In one embodiment, when a meeting is a meeting to which emailed invitations were sent to attendees prior to the start of the meeting, an invitation may effectively be re-sent to a device which was at a meeting location but has left the meeting location. That is, a meeting server may re-send an emailed invitation to a meeting upon detecting that a device which was present at a physical location associated with the meeting has left the physical location.

A participant who attends a meeting at a physical location may have more than one device in his or her possession. As such, multiple devices associated with the participant may be detected at the physical location. When the participant departs the physical location, or meeting location, while the meeting is ongoing, the multiple devices may be detected as having left the physical location. In one embodiment, one of the multiple devices may be selected as a substantially primary device to which a meeting link may be sent, if appropriate. That is, rather than provide a meeting link to all of the devices in the possession of the participant, a meeting link may instead be provided to one of the devices.

While a method of providing a meeting link to a device has generally been described as including a determining of whether to provide the meeting link to the device, it should be appreciated that in some instances, a meeting link may be substantially automatically provided to the device. In other words, upon determining that a device has departed a physical location associated with a meeting, the device may be provided with a link to join the meeting regardless of whether the device is currently in use.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
identifying a first device as being located at a first physical location, the first physical location being associated with a meeting;
determining when the first device is no longer located at the first physical location during the meeting;
when it is determined that the first device is no longer located at the first physical location during the meeting, determining whether to provide a meeting link to the first device, the meeting link being arranged to allow the first device to join the meeting; and
providing the meeting link to the first device if it is determined that the meeting link is to be provided to the first device.

2. The method of claim 1 wherein determining whether to provide the meeting link to the first device includes determining whether the first device is in a busy state.

3. The method of claim 3 wherein determining if the first device is in a busy state includes determining if the first device is on a call.

4. The method of claim 1 further including:
determining if a threshold amount of time has passed when it is determined that the first device is no longer located at the first physical location during the meeting, wherein providing the meeting link to the first device includes providing the meeting link to the first device if it is determined that the meeting link is to be provided to the first device and if it is determined that the threshold amount of time has passed.

5. The method of claim 1 wherein the first device is an authenticated device.

6. The method of claim 1 further including:
determining when the first device has activated the meeting link; and
joining the first device to the meeting when it is determined that the first device has activated the meeting link.

7. A tangible, non-transitory computer-readable medium comprising computer program code, the computer program code, when executed, configured to:
identify a first device as being located at a first physical location, the first physical location being associated with a meeting;
determine when the first device is no longer located at the first physical location during the meeting;
when it is determined that the first device is no longer located at the first physical location during the meeting, determine whether to provide a meeting link to the first device, the meeting link being arranged to allow the first device to join the meeting; and
provide the meeting link to the first device if it is determined that the meeting link is to be provided to the first device.

8. The tangible, non-transitory computer-readable medium of claim 7 wherein the computer program code configured to determine whether to provide the meeting link to the first device is configured to determine whether the first device is in a busy state.

9. The tangible, non-transitory computer-readable medium of claim 8 wherein the computer program code configured to determine if the first device is in a busy state is configured to determine if the first device is on a call.

10. The tangible, non-transitory computer-readable medium of claim 7 wherein the computer program code is further configured to:
determine if a threshold amount of time has passed when it is determined that the first device is no longer located at the first physical location during the meeting, wherein the computer program code configured to provide the meeting link to the first device is configured to provide the meeting link to the first device if it is determined that the meeting link is to be provided to the first device and if it is determined that the threshold amount of time has passed.

11. The tangible, non-transitory computer-readable medium of claim 7 wherein the first device is an authenticated device.

12. The tangible, non-transitory computer-readable medium of claim 7 wherein the computer program code is further configured to:
determine when the first device has activated the meeting link; and
join the first device to the meeting when it is determined that the first device has activated the meeting link.

13. An apparatus comprising:
an interface; the interface being arranged to enable the apparatus to communicate on a network;
a processor; and
logic arranged to be executed by the processor, the logic including a meeting support module, a device identification module, and a meeting link generation module, the meeting support module being configured to support a meeting, the device identification module being configured to identify a device present at a physical location associated with the meeting and to determine if the device has departed the physical location during the meeting, the meeting link generation module being configured to determine whether to provide a meeting link to the device if it is determined that the device has departed the physical location during the meeting and to provide the meeting link to the device through the network if it is determined that the meeting link is to be provided to the device, the meeting link being arranged to activated by the device to join the meeting.

14. The apparatus of claim 13 wherein the meeting support module is configured to join the device to the meeting when the device activates the meeting link.

15. The apparatus of claim 13 wherein the apparatus is a meeting server, and wherein the meeting is a collaborative session.

16. The apparatus of claim 13 wherein the meeting link generation module is configured to determine whether to provide the meeting link to the device by determining whether the device is in use, wherein if the device is in use, the meeting link generation module is configured to determine that the meeting link is not to be provided to the device.

17. The apparatus of claim 13 wherein the meeting link generation module is configured to determine if a threshold amount of time has passed when it is determined that the device has departed the physical location, and wherein the meeting link generation module is configured to provide the meeting link to the device if it is determined that the threshold amount of time has passed

18. The apparatus of claim 13 wherein the device is a phone, and wherein determining whether the device is in use includes determining whether the phone is engaged in a call.

19. The apparatus of claim 13 wherein the device identification module is further configured to authenticate the device.

20. The apparatus of claim 19 further including:
a storage module, the storage module being arranged to store information, wherein the device identification module is arranged to access the information to authenticate the device.
